(19) United States
(12) Patent Application Publication
(10) Pub. No.: US 2026/0311587 A1
(43) Pub. Date: Oct. 8, 2026

(54) INSECT TRAP REPLACEMENT NOTIFICATION AND METHODS FOR USING THE SAME

(71) Applicant: Silgan Dispensing Systems Corporation, Richmond, VA (US)

(72) Inventor: Zhili Luo, Glen Allen, VA (US)

(73) Assignee: Silgan Dispensing Systems Corporation, Richmond, VA (US)

(21) Appl. No.: 19/640,081

(22) Filed: Apr. 6, 2026

Related U.S. Application Data
(60) Provisional application No. 63/785,039, filed on Apr. 8, 2025.

(51) Int. Cl. G08B 21/24; A01M 1/10

(52) U.S. Cl. CPC G08B 21/24; A01M 1/10

(57) ABSTRACT

An insect trap replacement notification system and insect trap includes a timer and a light wherein the light may be activated – or deactivated – to notify a user of the need to change a cartridge in the insect trap upon the elapse of a fixed amount of time.

### CROSS-REFERENCE TO RELATED APPLICATIONS

The present application claims the benefit of U.S. Provisional Patent Application No. 63785039, filed Apr 8, 2025, the entire contents of which is incorporated herein by reference.

### BACKGROUND OF THE INVENTION

Field of the Invention: Embodiments of the invention relate to visual notifications to indicate the need to check an insect trap or other device for replacement or refill.

Description of Related Art: Insect traps are well known and are used for a variety of purposes. New, plug-in traps have been developed to attract and catch insects of different varieties. Refill systems are offered for such traps. However, users are unaware of when a trap needs to be changed. In addition, as sustainability requirements and the desire to use traps with refills becomes more prevalent, there is a need for systems or indicators to notify a user of the need to replace or refill such traps.

### BRIEF SUMMARY OF THE INVENTION

According to certain embodiments of the invention, a notification system includes a timer and a light, wherein the timer is set for a fixed period of time upon replacement or refill of a trap system and wherein upon expiration of the fixed period of time, the light is activated to notify a user that it is time to replace or refill the trap.

In other embodiments, a notification system may include a power source, a timer, and a light, wherein the timer and light are powered by the power source. The power source may be a battery, a 12-volt power source, wall outlet, or other electrical source. In some embodiments, the notification system may also include a back-up battery or power source in the event that the primary power source is disconnected.

In still other embodiments of the invention a timer and light are incorporated with an existing refill plug-in bug trap system such that the timer is reset each time the refill is replaced and the light is toggled on at the end of a fixed time period. The light may be turned off by removal and/or replacement of the refill portion. In other embodiments, a switch may be included to toggle the light off following activation by a timer. In some embodiments, if the light is toggled to an off position without replacement of the refill, the timer may be re-activated for another period of time (the same length or shorter than the original period) so that a user may elect not to remove the refill before it is full of bugs.

### BRIEF DESCRIPTION OF THE SEVERAL VIEWS OF THE DRAWINGS

While the specification concludes with claims particularly pointing out and distinctly claiming particular embodiments of the present invention, various embodiments of the invention can be more readily understood and appreciated by one of ordinary skill in the art from the following descriptions of various embodiments of the invention when read in conjunction with the accompanying drawings in which:

FIG. 1 illustrates an embodiment of the invention; and

FIG. 2 illustrates another embodiment of the invention.

### DETAILED DESCRIPTION OF THE INVENTION

According to embodiments of the invention, an insect trap notification system includes an insect trap 100 having a power source 130, a timer 140, and a light 120.

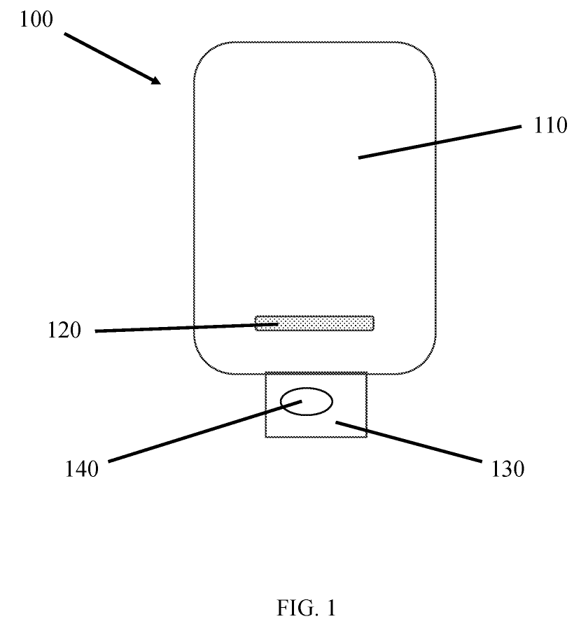

An example of an insect trap notification system according to embodiments of the invention is illustrated in FIG. 1. As illustrated, an insect trap 100 may include a plug-in insect trap such as the ZEVO® brand flying insect trap. The insect trap 100 may include a base or frame and an insect trap cartridge inserted thereon or therein. The power source 130 may include a plug-in power source as known with various brands of insect traps. The unique feature of the insect trap notification system of the present invention is that a timer 140 and a light 120 are connected to the power source 130 to notify a user of the need to replace the insect trap cartridge associated therewith. The timer 140 may be configured to reset upon the plug-in of the insect trap 100 or upon the removal and replacement of a refill cartridge used with the insect trap 100. At the same time, the light 120 may be turned off. After a pre-set period of time counted by the timer 140, the light 120 may be activated to notify a user that the insect trap 100 cartridge needs to be checked or replaced.

According to some embodiments of the invention, the insect trap 100 includes a power source 130 such as the plug power sources used with known plug-in insect traps. In other embodiments, the power source 130 may be a battery and the insect trap 100 may be a stand-alone unit that is not connected to other power sources. In still other embodiments of the invention, the power source 130 may include a battery back-up such that if the main power source 130 is interrupted, the battery back-up will ensure the continued operation of the timer 140 and is capable of powering the light 120 at that point when the timer 140 has reached the timer’s 140 set time-period.

In some embodiments of the invention, the timer 140 may be reset for a shorter time period such that if a user checks the refill cartridge and it does not need to be changed, the user can reset the timer 140, and turn off the light 120, for another period before which the timer 140 will again light the light 120 alerting the user to the need to check the refill cartridge. This may be accomplished with a toggle switch, a button, by removing and replacing the refill quickly is a set period of time, or in another manner.

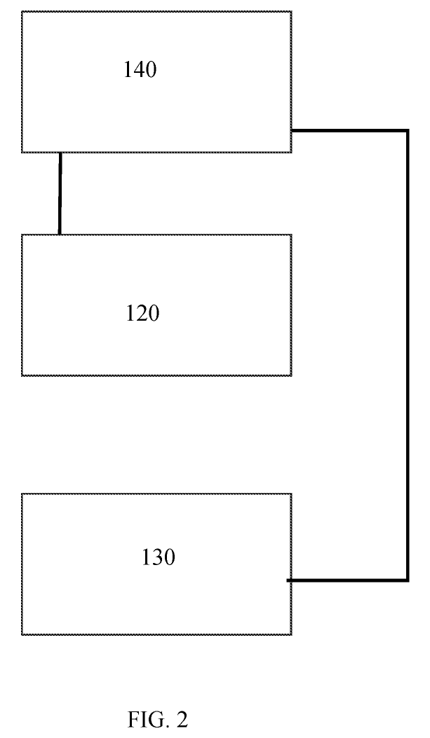

As illustrated in FIG. 2, an insect trap notification system may include a timer 140 connected to a power source 130. The timer 140 may act as a switch, providing power to the light 120 after reaching a set state. The timer 140 may also disable or stop power to the light 120.

An example of an insect trap notification system according to embodiments of the invention includes an insect trap 100 plug-in system having a printed circuit board connected to or having timing circuits built therein to create a timer 140. The printed circuit board may be connected to a power source 130. Upon insertion of a cartridge into the insect trap 100, a switch is activated to activate the timer 140 or timing circuitry of the printed circuit board. The timer 140 is programmed to direct power to the light 120 after a pre-determined period of time. Upon reaching that time period, the light 120 is powered and it lights up, providing a notification that the cartridge needs to be replaced. When the cartridge is removed, the timer 140 resets and the light is turned off. Insertion of a new cartridge re-activates the timer 140 and the insect trap notification system.

In other embodiments, the timer 140 and light 120 may require that the insect trap 100 be unplugged or disengaged from the power source 130 in order to reset.

In still other embodiments, the light 120 may be lit during active periods and turned off upon the expiration of the time set with the timer 140 such that a user knows that when the light goes out, the cartridge needs to be replaced.

In some embodiments of the invention, if a cartridge is not included in the insect trap 100 when attached to a power source 130, the light 120 may activate to notify the user of the need to add a cartridge to the insect trap 100.

Having thus described certain particular embodiments of the invention, it is understood that the invention defined by the appended claims is not to be limited by particular details set forth in the above description, as many apparent variations thereof are contemplated. Rather, the invention is limited only be the appended claims, which include within their scope all equivalent devices or methods which operate according to the principles of the invention as described.

What is claimed is:

1. An insect trap notification system, comprising:
an insect trap;
a timer; and
1a light.

2. The insect trap notification system of claim 1, wherein the insect trap comprises:
an insect trap frame;
a plug for connection to a power source; and
an insect trap cartridge mounted to the insect trap frame.

3. The insect trap notification system of claim 2, wherein the timer is set to activate the light after a period of time following the connection of the plug to a power source.

4. The insect trap notification system of claim 3, wherein the timer may be reset by the removal and replacement of a insect trap cartridge.

5. An insect trap, comprising:
an insect trap frame;
an insect trap cartridge attached to the insect trap frame;
a power source;
a timer connected to the power source; and
a light connected to the timer.

6. The insect trap of claim 5, wherein the power source comprises a plug and an outlet, wherein insertion of the plug into the outlet provides power to the insect trap.

7. The insect trap of claim 5, wherein the power source comprises a battery.

8. The insect trap of claim 5, wherein the power source comprises a back-up battery.

9. The insect trap of claim 5, wherein the timer comprises a printed circuit board comprising timing circuits.

10. The insect trap of claim 5, wherein the timer is configured to provide power to the light.

11. The insect trap of claim 5, wherein the light is selectively connected to the power source.

12. The insect trap of claim 5, wherein the timer acts as a switch to provide power to the light.

13. The insect trap of claim 12, wherein removal of a cartridge switches the timer into a state where power is not provided to the light.

14. The insect trap of claim 12, wherein insertion of a cartridge into the insect trap frame activates the timer.
